(19) United States
(12) Patent Application Publication
(10) Pub. No.: US 2017/0053551 A1
(43) Pub. Date: Feb. 23, 2017

(54) MEAL PLANNING DEVICE AND METHOD

(71) Applicant: VICTOR R. PRISK, BLAWNOX, PA (US)

(72) Inventor: VICTOR R. PRISK, BLAWNOX, PA (US)

(21) Appl. No.: 15/240,434

(22) Filed: Aug. 18, 2016

Related U.S. Application Data
(60) Provisional application No. 62/206,544, filed on Aug. 18, 2015.

(51) Int. Cl. G09B 19/00; G09B 5/02

(52) U.S. Cl. CPC G09B 19/0092; G09B 5/02

(57) ABSTRACT

A method of creating a meal plan includes receiving user information, determining target amounts of leucine, calories and one or more macronutrients per meal based on the received user information, providing a user interface to allow the user to add food items to a created meal or remove food items from the created meal, determining amounts of leucine, calories and one or more macronutrients provided by food items included in the created meal, displaying a comparison of the amounts of leucine, calories and one or more macronutrients provided by food items in the created meal and the target amounts of leucine, calories and one or more macronutrients per meal on the user interface, updating the displayed comparison each time the user adds a food item to the created meal or removes a food item from the created meal.

### CROSS-REFERENCE TO RELATED APPLICATIONS

This patent application claims the priority benefit under 35 U.S.C. §119(e) of U.S. Provisional Application No. 62/206,544 filed on Aug. 18, 2015, and entitled, “LEUCINE FACTOR SYSTEMS AND METHODS,” the contents of which are hereby incorporated herein by reference.

### BACKGROUND

Field

The disclosed concept generally relates to meal planning devices and methods. More particularly, the disclosed concept relates to meal planning devices and methods for calculating and optimizing the leucine content in meals.

Description of Related Art

Nature inherently wants to conserve energy and building muscle takes lots of energy. Muscle is heavy and metabolically active. If there's no fuel available, a body can't build muscle. The body has to be able to sense whether there is enough fuel to build muscle.

It was once thought that insulin was the driving force behind muscle growth. That is, if sugar calories were available muscle could grow. The existence of plenty of sugar (glucose) in the system only tells the body that there is no need to break down muscle for energy. Thus, insulin's main role is to store those nutrients and avoid breakdown of what was stored.

Insulin encourages the body to store glucose in muscle, liver, and fat. It clears toxic sugar out of the blood. Sugar caramelizes the insides in a reaction with proteins that makes them foreign to the immune systems. The subsequent inflammation from sugar leads to further tissue damage, insulin resistance, and an inability to repair muscles after exercise.

In fact, it only makes sense that nature would have a non-insulin dependent way of differentiating whether or not there are nutrients available to build muscle. Since bodies can make glucose from particular amino acids and fats, glucose isn't a good way to sense whether nutrients are available in the environment to grow. In other words, a better signal is needed, a “key” to build muscle other than glucose because bodies already auto-regulate blood glucose to feed the brain.

It makes sense that the nutrient signal from our food comes in the form of an essential nutrient that bodies can't make and can't become glucose. There are essential amino acids, essential fats, but no essential carbohydrates. Since the essential fats play a structural role and combine with a glycerol backbone that can be converted into glucose this leaves the essential amino acids as a potential “key” to turn on a nutrient sensor.

In particular, the essential amino acids that the body can't convert to glucose (i.e. non-gluconeogenic or purely ketogenic), lysine and leucine, make the most sense as a nutrient to turn on muscle. However, lysine can be converted to carnitine for fat shuttling and its uptake is easily inhibited by leucine; thus, leucine is preferred.

Science supports that there's a threshold in diets that must be met in order to turn on muscle protein synthesis. One study demonstrated that distributing protein evenly throughout meals in the day was more effective than the typical “skewed” American diet. Most Americans eat very little protein at breakfast, a little more at lunch, and a lot more at dinner. When scientists put equal amounts of protein at each meal with the same daily total as a skewed diet the equally partitioned meals resulted in better muscle protein synthesis.

Further, when balanced protein is fed to those dieting with four meals per day they maintain muscle better than a skewed protein pattern. Just like any other stimulus, whether lifting for a body part or eating a meal, the muscle building process needs some downtime to restart growth. It is presumed by this research on skewed diets that a threshold for turning on muscle protein synthesis wasn't being met by the lower protein meals (breakfast and lunch). Science has suggested that the threshold for turning on muscle protein synthesis is met by the leucine content of a protein. Bodies sense the leucine content of our meals through complex molecular mechanisms. Leucine acts as the “key” to turn on muscle protein synthesis through direct and indirect activation of the mTOR pathway. Moreover, it does this in a manner that doesn't depend on the presence of insulin. Thus, the leucine content of a meal could affect a meal's ability to build muscle after training.

Despite the confusion created by the RDA of 0.8 g per kilogram bodyweight of protein required each day, sports science shows that this is highly inadequate for strength training athletes. Furthermore, the RDA doesn't say “high quality proteins”. All proteins are not created equal in their ability to support metabolism and build muscle. Studies show that it takes 30% more soy protein to have the same effect on muscle protein synthesis as whey protein. Whey protein has 30% more leucine gram for gram than soy protein.

Whey protein is the protein richest in leucine. Whey and casein make up the milk proteins. Cow's milk contains 80% casein and 20% whey. However, human milk contains 60% whey and 40% casein. Mother's milk contains nearly 10% leucine similar to whey protein concentrates.

Some believe that once leucine has reached a minimum threshold, often around ˜2 grams in a meal, muscle protein synthesis is maximally turned on and extra leucine won't have a greater effect. However, a study in relatively young active-duty military personnel demonstrated that 3.5 grams of leucine mixed with essential amino acids was more effective in turning on muscle protein synthesis than 1.87 grams of leucine with the same amino acids. The older one gets, the less sensitive one becomes to leucine's signal to make muscle.

Leucine is the key to “turn on the car”, but fuel is needed to keep it running which also requires intermittent rest stops. Leucine acts as a switch to turn on muscle growth but if the essential amino acids found in complete proteins aren't available there are no materials to build the muscle. When scientists put leucine in the drinking water of rats, despite the constant leucine stimulus, they failed to build more muscle. When there is a “de-sychronization” in the leucine stimulus and availability of essential amino acids, one fails to achieve the goal of turning on muscle growth.

In addition, leucine may act as a signal to limit food intake by acting on mechanisms in the brain. If one stops eating without having eaten a good blend of essential amino acids from food, muscle won't grow. Leucine is nature's way of knowing that high quality protein has been eaten and one can build muscle. One shouldn't take leucine supplements by themselves to build muscle.

Based on the lack of information available relating to leucine, there is a need for the design and development of systems and methods for optimizing the leucine content of the proteins a person eats. All proteins have a different percentage of leucine. One can optimize muscle metabolism and insulin sensitivity with the effects of leucine.

### SUMMARY OF THE INVENTION

These needs and others are met by embodiments of the disclosed concept, which provide a method of meal planning that determines target amount of leucine, calories, and one or more macronutrients and facilitates creating a meal that meets the target amounts.

In accordance with aspects of the disclosed concept, a method of creating a meal plan comprises: receiving user information; determining target amounts of leucine, calories and one or more macronutrients per meal based on the received user information; providing a user interface to allow the user to add food items to a created meal or remove food items from the created meal; determining amounts of leucine, calories and one or more macronutrients provided by food items included in the created meal; displaying a comparison of the amounts of leucine, calories and one or more macronutrients provided by food items in the created meal and the target amounts of leucine, calories and one or more macronutrients per meal on the user interface; and updating the displayed comparison each time the user adds a food item to the created meal or removes a food item from the created meal.

In accordance with other aspects of the disclosed concept, an electronic device comprises: an input device; a display; a memory having stored therein a routine; and a processing unit structured to execute the routine, wherein executing the routine causes the processing unit to: receive user information; determine target amounts of leucine, calories and one or more macronutrients per meal based on the received user information; provide a user interface on the display to allow the user to add food items to a created meal or remove food items from the created meal; determine amounts of leucine, calories and one or more macronutrients provided by food items included in the created meal; control the display to display a comparison of the amounts of leucine, calories and one or more macronutrients provided by food items in the created meal and the target amounts of leucine, calories and one or more macronutrients per meal on the user interface; and updating the displayed comparison each time the user adds a food item to the created meal or removes a food item from the created meal.

### BRIEF DESCRIPTION OF THE DRAWINGS

FIG. 1 is a flowchart of a method of planning a meal in accordance with an example embodiment of the disclosed concept;

FIG. 2 is a schematic diagram of an electronic device in accordance with an example embodiment of the disclosed concept; and

FIGS. 3-5 are screens of a user interface in accordance with an example embodiment of the disclosed concept.

### DESCRIPTION OF THE PREFERRED EMBODIMENTS

As employed herein, the term “processor” shall mean a programmable analog and/or digital device that can store, retrieve and process data; a controller; a control circuit; a computer; a workstation; a personal computer; a microprocessor; a microcontroller; a microcomputer; a central processing unit; a mainframe computer; a mini-computer; a server; a networked processor; or any suitable processing device or apparatus.

As employed herein, the term “number” shall mean one or an integer greater than one (i.e., a plurality).

As employed herein, the term “leucine factor point”, “L-Factor point” or “LFP” shall mean 0.1 g of leucine. For example, 10 LFPs=1 g of leucine.

The disclosed concept generally includes devices and methods for planning meals including calculating leucine content in foods. The disclosed concept further includes optimizing the level of leucine to achieve various nutrition and health goals. Moreover, in some embodiments, aspects of the disclosed concept may be implemented in electronic devices such as, for example and without limitation, a mobile phone such as a smartphone. invention includes software for use with hand-held devices, e.g., a smartphone, to simplify the calculation of leucine content and corresponding inputs, to create a diet and exercise plan, track progress and achieve goals.

In accordance with some embodiments of the disclosed concept, users are able to determine their daily calories and macronutrients needed. They can optimize their leucine content of each meal that they create based on their chosen protein. Every protein has different rations of amino acids and thus different quantities of leucine per ounce. The LFPs of a food are the number of grams of leucine per ounce of protein multiplied by a factor of 10. For instance, salmon has 0.58 grams of leucine per ounce and thus 5.8 LFPs per ounce. Chicken breast has 7.2 LFPs per ounce. The goal is to attain 0.2 LFP per pound of bodyweight per meal.

By optimizing the leucine content of meals one is able to capitalize on leucine's unique properties of enhanced muscle protein synthesis and prevention of muscle protein breakdown, enhance insulin sensitivity, and reductions in appetite. Leucine is a very special branched chain amino acid that has properties that go beyond any of the other essential amino acids.

The Leucine Factor diet is based on scientific evidence to match ones goals. Whether one wants to lose weight, gain muscle, or just live healthy this diet will guide the way. Some embodiments of the disclosed concept can guide one through making the diet program to achieve goals and maximize leucine with each meal. A person generally fits into one of three categories:

### Health Maintenance

At an ideal bodyweight and want to maintain that weight while living healthy for longevity. The focus is on balanced nutrition to support a desired level of activity. One may also like to take a holistic approach to longevity.

### Build Muscle

This category is for those that want to build muscle for bodybuilding or performance. This can also be for those who want to improve their strength. Muscle is metabolic currency and this category needs more energy and fuel to build. Gain as much muscle as needed and fuel competitive spirit.

### Get Lean

Desire to lose the extra fat weight while maintaining muscle. Losing weight means burning fat and possibly losing some muscle. A proper diet and the right amount of exercise and can burn the fat while keeping the muscle.

The Leucine Factor diet is based on a number of scientific principles in order to maximize lean muscle mass while losing fat or “beefing up”. The goal of any of the above categories is to stay anabolic and maintain “metabolic currency”. Losing weight is largely a catabolic process, but anabolic stimuli can still help maintain muscle while losing the fat. One can actually burn fat and build muscle at the same time; the scale may come down as wanted or expected. Muscle has more density than fat and building it maintains weight. This diet helps to maintain muscle by doing one or more of the following:

### Avoids the Starvation Response

The Leucine Factor Diet employs calculations or real-time biometric measurements of daily caloric expenditure to make sure that one is getting enough calories for goals. If trying to burn fat, produce most of the caloric deficit through exercise while limiting caloric deficit from food. One should never restrict more than 250 calories from diet and the total energy deficit should not initially exceed 500 calories (250 from food and 250 from exercise). Exceptions may apply in cases of health risks where fat needs to come off faster. With an emphasis on healthy fats, protein, fibrous veggies, and nutrient timing one will feel fuller and less “starved” than on other more restricted diet programs.

### Optimizes Protein Intake

The ACSM and ADA recommend 0.8 grams of protein per pound (for strength and endurance training athletes. This is nearly twice the amount of the RDA. On the 5 meals a day (5MAD) diet this comes out to 24 grams of protein per meal for a 150 lb. man. This is not enough protein to supply necessary amino acids for maximizing muscle growth and/or maintenance. Particularly, this is not enough protein for optimizing leucine delivery. Personal experience and science supports the use of substantially more protein to maximize muscle growth and prevent breakdown in dieting. Sometimes one may need to reduce carbohydrate and fat intake to maximize fat burning. In this case, one will go into starvation mode without the addition of protein for calories. Increasing the proportion of calories from protein increases metabolism and improves mobilization of fat stores. The Leucine Factor diet includes no less than 1 gram per pound bodyweight per day.

### Provides Optimal Leucine at Each Meal

Leucine is an amazing amino acid. It is the signal for muscle to build muscle when adequate nutrients are present. Studies show that the leucine content of a protein affects its ability to boost muscle protein synthesis. Studies also support that leucine can maximize muscle protein synthesis with at least 0.045 grams per kilogram of bodyweight per meal.

A study has shown that at rest and after resistance exercise consumption of whey protein produced ˜30% greater increases in muscle protein synthesis over soy supplementation. Whey protein happens to have nearly 30% more leucine than soy. Another study has shown that an even distribution of protein throughout the day leads to more muscle protein synthesis, suggesting that a threshold wasn't being met with the typical skewed diet of eating more protein at dinner and less at breakfast and lunch. This threshold was the amount of leucine needed to turn on muscle protein synthesis.

One myth that comes up often is that the body can only absorb 20-30 g of protein per meal anyway. If this was the case, it would be very difficult to reach the 0.045 grams per kilogram bodyweight of leucine per meal. This myth evolved from studies saying that 20 g of protein or essential amino acids maximizes muscle protein synthesis. However, those studies did not evaluate the effect of consuming more protein on limiting muscle protein breakdown. Muscle protein is in constant flux with synthesis and breakdown. Physical activity tries to break it down and the body has to build it up in rest and recovery. If one consumes more protein it will actually help limit muscle breakdown proportionately. Eat protein to build and prevent breakdown of muscle.

In light of the leucine threshold to be reached with each meal, focus on the leucine content of meals. Each food has a different percentage of leucine. Thus, a metric called the “L-Factor” helps recognize foods with enough leucine to meet needs with each meal. An L-Factor point is 10× the number of grams of leucine in 1 ounce of a food.

Following are some examples of the number of L-Factor points provided by 1 ounce of different foods:

### Whole Egg=3 Pts

### Turkey Breast=5 Pts

### Salmon=6 Pts

### Romano Cheese=9 Pts

Whey Isolate 10 grams=10 Pts

The “L-Factor” applies points to each food based on the leucine content per ounce of that food. With each meal one needs to obtain 0.20 points per pound of bodyweight. Thus, a 150 lb. man needs: 150×0.20=˜30 L-Factor Points per meal to maximize leucine. As an example, 1 ounce of salmon has 6 L-Factor Points, thus the 150 lb. man would have to eat: 30/6=5.0 ounces of salmon to meet L-Factor Points needed for such a meal. Of note, science supports a minimum intake of ˜20 L-Factor Points per meal with higher amounts leading to more muscle activation.

### Maximizes Antioxidant and Micronutrient Intake

Through the use of fibrous and green leafy veggies The Leucine Factor diet maximizes intake of vitamins and minerals that are needed to recover from workouts and pre-biotic fiber to boost the bugs in the belly. The vitamins, minerals, and antioxidants from whole foods are very well absorbed. Veggies are also rich in nitrates that help to deliver valuable nitric oxide. Nitrates and the nitric oxide they produce improve performance, increase delivery of oxygen and nutrients to muscle, and help control blood pressure.

### Gives Goal Oriented Supplement Advice

Nutritional supplements are essential to the success unless one is a meticulous eater. When not able to maximize protein and leucine content through whole foods (especially due to caloric restrictions, food volume, or time limitations) supplements are needed. A multivitamin ensures fulfillment of micronutrient needs. Some supplements are essential to athletes and very active individuals. Supplements like creatine, beta-alanine, arginine/citrulline, and betaine boost strength and muscle endurance leveling the playing field. Some supplements help increase metabolic rate and burn more fat throughout the day.

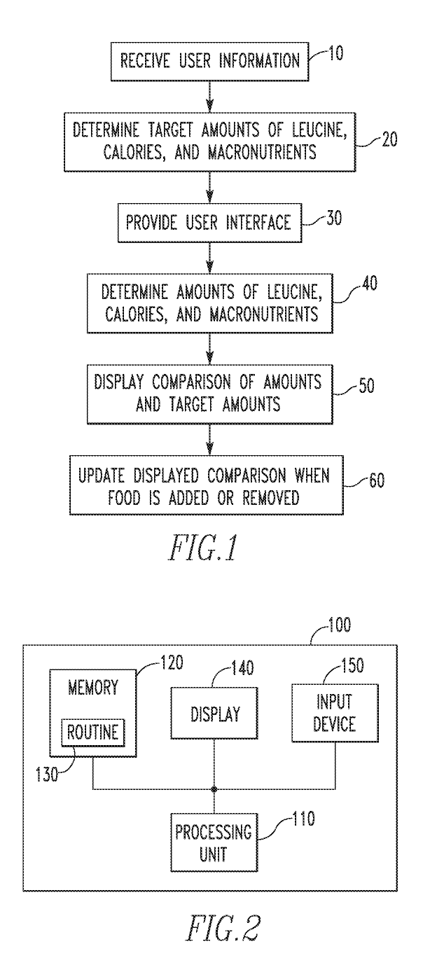

FIG. 1 is a flowchart of a method of planning a meal in accordance with an example embodiment of the disclosed concept. The method of FIG. 1 can assist one in creating an optimized diet for obtaining goals. The diet can be adjusted weekly depending on progress, attitude, energy level, and health. Sugars, desserts, and alcohol are never included in the Leucine Factor diet. If added, need to make up for it through added exercise or reductions in carbohydrate or fat calories.

At 10, information about the user is received. The information may include, for example, the height, weight, age and gender of the user. In some example embodiments, the information may include the body fat percentage of the user. Furthermore, the user information may include information about an activity factor of the user. Example activity factors may include, without limitation, sedentary, lightly active, moderately active, and very active. Additionally, the user information may include the user's goal. The user's goal may include, for example and without limitation, one of health maintenance, build muscle and get leaner.

The user information may be obtained in any suitable manner. For example, in some embodiments of the disclosed concept, the user may interact with a user interface to enter the user information.

At 20, target amounts for leucine, calories and macronutrients for the user are calculated. In some example embodiments of the disclosed concept, the target amounts may be calculated per meal. Calculating the target amounts is described in more detail below. The example case for calculating the target amounts is a 130 lb. woman who is 35 years old, 5′4″, 20% body fat, wants to be 120 lbs., has an activity factor of sedentary, and has a goal of health maintenance. However, it will be appreciated that the calculations of the target amounts may be applied to any user.

As a first, step, the total daily energy expenditure of the user is calculated. For example and without limitation, the Harris-Benedict Equations or the Katch-McArdle Formula may be used to calculate the total daily energy expenditure. The Harris-Benedict equations only require height, weight, age, and sex. This calculation is done using a goal weight. That is, if the user weighs 130 lbs., but wants to weigh 120 lbs., the goal weight of 120 lbs. is used in the equations. The Katch-McArdle Formula provides a more accurate assessments and can be done if body fat percentage is known. In the equation below, a basal metabolic rate (BMR)×1.2 is used. 1.2 is the activity factor for a sedentary individual. This gives a baseline on which to add or subtract calories in the form of foods or exercise.

Body fat percentage can be measured in a number of ways. The best way would be to use skin fold calipers. Otherwise some medical offices offer testing through machines like the BodPod or Dexa Scanning. This can be expensive and limit ability to adjust diet to progress due to lack of availability and infrequency of testing.

### Harris-Benedict Equation

Equations for measuring daily caloric expenditure can vary + or −30% for individuals. All have different metabolic systems and environments in which one lives that affect those systems. These numbers are meant to be a starting point and calories should be adjusted daily up or down each week if not gaining or losing what one expects. The equations are as follows:

### Men:

BMR=66+(6.23×weight in pounds)+(12.7×height in Inches)−(6.8×age in years)

### Women:

BMR=655+(4.35×weight in pounds)+(4.7×height in Inches)−(4.7×age in years)

### Example Case:

BMR=655+(4.35×120)+(4.7×64)−(4.7×35)=655+(522)+(300)−(165)=1312 Calories per day

Katch-McArdle Formula (Use if Know Lean Mass from Body Fat Percentage):
BMR=370+(9.8×lean mass in pounds)

### Calculation for Lean Mass

Body Fat Percentage of total body weight=total fat weight
If woman is 20% body fat; 0.20×130=26 lbs. of fat
Lean mass=total body weight−total fat weight
130−26=104 lean pounds
BMR=370+(9.8×104)=1389 calories per day.

This number is higher than the Harris Benedict equation. If one has more lean mass, one will burn more calories in the day. Knowing body fat percentage gives a slightly more accurate reading based on the norms for the general population. However, focus on the fact that these numbers are just estimates to give a starting point for the diet. These numbers have inherent problems because everyone has different metabolism. One can adjust the diet as one progresses to match goals. For instance, if the goal is to lose 1 pound per week and in the first week only 0.5 lbs. is lost despite being strict on the diet, one will know there is a need to add an extra 1750 calorie deficit from exercise or diet changes over the course of the week. 3500 calories is approximately equivalent to 1 lb. of fat. Thus, 1750/7=250 calories per day. 3500 Calories Burned=1 Pound of Body Fat Burned.

Once BMR is obtained, how active one is daily needs to be considered to get the total daily energy expenditure. An activity monitor can help one be more accurate with this measurement otherwise, standardized numbers need to be used. The Katch-McArdle Formula provides activity factors that can be applied to either of the BMR formulas above. Multiply BMR by the activity factor to obtain a simple estimate of the total calories burned each day. The activity factor may be obtained from the user. The following are some examples of activity factors.

### Activity Factors:

If Sedentary (little or no exercise):

Calorie-Calculation=BMR×1.2

If one is Lightly Active (light exercise/sports 1-3 days/week)

Calorie-Calculation=BMR×1.375

If Moderately Active (moderate exercise/sports 3-5 days/week)

Calorie-Calculation=BMR×1.55

If Very Active (hard exercise/sports 6-7 days/week)

Calorie-Calculation=BMR×1.725

If Extra Active (very hard daily exercise/sports & physical job or 2× day training)

Calorie-Calculation=BMR×1.9

In some example embodiments of the disclosed concept, as an alternative to an activity factor, an adjustment may be made based on an estimated amount of calories burned per day from exercise. For example and without limitation, the total daily calorie expenditure may be calculated as BMR×1.2+estimated calories burned. The total daily energy expenditure result of the example case is 1312×1.2=1575.

Once the total daily energy expenditure is calculated, another adjustment may be made based on the user's goal. For example, if the user's goal is health maintenance, no further adjustment needs to be made and the calculated total daily energy expenditure may be used as the target amount of calories per day. As previously described, the total amount may be calculated on a per meal basis. In the case of a 5MAD plan, the target amount of calories per meal will be the total daily energy expenditure divided by 5. For the example case, the target amount of calories per meal is 1575/5=315 calories per meal.

It will be appreciated that the disclosed concept may be applied using any other number of meals per day as well. The target amount of calories per day under the goal of health maintenance is the target amount of calories to maintain the user as his or her goal weight. Estimates of calorie expenditure based on the activity factors or other measures (i.e. activity monitors, cardio equipment calculations, or activity estimates) have inherent statistical error and the user may need to adjust the diet according to progress toward the goal.

If the user's goal is to build muscle, 250 calories are added to the total daily energy expenditure to reach the target amount of calories per day. This will ensure that the user will have plenty of calories to remain anabolic. If more than 250 extra calories are added, one may put on a little fat weight. Any additional calories should be added from protein. Additional protein calories can add mass without affecting fat accumulation. High quality leucine-rich proteins like whey isolates should also be utilized.

If the user's goal is to get lean, up to 250 calories should be subtracted from the total daily energy expenditure to reach the target amount of calories per day. If more than 500 calories per day are subtracted from the total daily energy expenditure, there is the risk of significant muscle loss and a slowing of basal metabolic rate with the starvation response. Slow and steady weight loss is always better than rapid weight loss (with only few exceptions such as in morbid obesity and physique contest dieting).

Once the total amount of calories are calculated, the amounts of macronutrients may be calculated. Macronutrients include protein, fat and carbohydrates (carbs). In accordance with some embodiments of the disclosed concept, the target amount of protein will be a minimum of 1 gram per pound and enough to generate 0.20 L-Factor Points per pound per meal.

Subtract the number of calories obtained from 1 gram per pound bodyweight of protein from target amount of calories. This is calculated as grams of protein×4 calories per gram. Essentially this is the same as calculating:

Target Amount of Calories−(4×Goal Bodyweight)=calories left over after protein needs are met.

For example, in the example case, the target amount of protein per day is 120 g, which is 1 g per pound of bodyweight and the corresponding number of calories is 4×120=480. The amount of calories left after the minimum amount of protein is consumed is 1575−(4×120)=1095.

After the protein calories have been subtracted, divide the remaining calories into fat and carbohydrate calories based on the user's goal category. Fats provide 9 calories per gram, and carbohydrates provide 4 calories per gram.

If the user's goal is health maintenance, divide the remaining calories 50/50 between carbs/fats. If the user's goal is to build muscle, divide the remaining calories 60/40 carbs/fats. If the user's goal is to get lean, divide the remaining calories 40/60 carbs/fats. The example case uses the health maintenance goal so the target amount of carbs and fat per day is 50% of 1095=548 calories as carbs/4 calories per g=137 g carbs per day and 50% of 1095=548 calories as fat/9 calories per g=61 g fat per day.

Once the amounts of macronutrients per day are calculated, divide the amounts by the number of meals per day to calculate the amount of macronutrients per meal. For the example case, use 5 meals per day.

120 g of protein per day=24 g of protein per meal
137 g of carbs per day=27 g of carbs per meal
61 g of fat per day=12 g of fats per meal

In addition to the calculating the target amounts of calories and macronutrients per meal, the target amount of leucine per meal is also calculated. In some example embodiments of the disclosed concept, the target amount of leucine per meal is calculated as 0.2 LFPs per pound of bodyweight per meal (1 LFP=0.1 g of leucine). For the example case, the target amount of Leucine per meal is 0.2×120=24 LFPs.

At 30, the user is provided with a user interface for adding foods to a meal or removing foods from a meal. The user interface may organize lists of foods into the categories of proteins, carbs, fats, and supplements. The lists of foods may include a name of the food and an amount of the food (i.e., a weight of the food). The user interface may also allow the user adjust the amount of a selected food in the meal.

The user interface may also display the LFPs corresponding to each food in the lists of food. In some example embodiments of the disclosed concept, the amount of the foods in the protein category may be automatically set to the amount corresponding to the target amount of Leucine. For example, for the example case, the target amount of Leucine is 24 LFPs and some of the foods and their corresponding amounts listed in the protein category may be:

### Chicken Breast (Ground)—3.3 oz, 24.0 pts

### Turkey Breast—4.5 oz, 24.0 pts

### Ostrich (Top Loin)—3.7 oz, 24.0 pts

### Lean 93% Ground Turkey—5.5 oz, 24.0 pts

In the example above, the amounts of each of the foods listed above have been automatically adjusted to meet the target amount of Leucine for a meal. Adding one food from the protein category will cause the meal to reach the target amount of Leucine. Additional foods from the protein category or other categories can then be added to meet the target amount of calories and other macronutrients.

The amount of the foods listed in each of the categories may also be adjusted based on foods based on foods already included in the meal. For example, the amount of foods may initially be listed based on a predetermined serving size. However, as foods are added to the meal, adding the predetermined serving size of a food may cause the target amount of calories to be exceeded. In this case, the amount of food listed may be reduced so that adding it will not cause the total amount of calories to exceed the target amount of calories by a threshold amount. In some embodiments, similar adjustments may be made based on other target amounts such as the target amounts of fats or carbs.

At 40, the amount of leucine, calories and macronutrients included in a meal created by the user are calculated. As previously described, the meal is created by adding food via the user interface. Each food includes a corresponding amount of leucine, calories and each macronutrient per unit weight. The corresponding amounts of leucine, calories and each macronutrient per unit weight may be stored in, for example, a computer readable medium. The corresponding leucine, calories and each macronutrient per unit weight for each food in the created meal may be retrieved from the computer readable medium and be multiplied by the amount of the food in order to determine the amount of leucine, calories and each macronutrient provided by the food. The amount of leucine, calories and each macronutrient provided by the meal may be determined by summing the amounts provided by each food in the meal.

At 50, a comparison of the amount of leucine, calories and each macronutrient and the target amount of leucine, calories and each macronutrient is provided to the user. For example, the comparison may be displayed to the user. In addition to displaying the comparison, a determination may be made whether each amount is within a threshold amount of the target amount. The threshold amounts may be absolute amounts or percentages of the target amount. Various alerts may be provided to the user if the amounts of leucine, calories and each macronutrient are not within a threshold amount of the target amount. For example, color coding of the displayed amount of leucine, calories and each macronutrient may be provided as an alert. In some embodiments, text displaying the amount of calories may change color when the amount of calories exceeds the target amount by the threshold amount.

In some embodiments of the disclosed concept, the user may be alerted when the amount of leucine is below the target amount. The user may also be prompted to add a supplement to boost the amount of leucine. For example, if the user initially adds a food from the fats category to the meal that has less than the target amount of leucine, the user may be alerted and prompted to boost the amount of leucine in the meal.

At 60, the displayed comparison is updated each time the user adds or removes a food from the meal. In this manner, the user can easily identify any deficiencies in the meal. For example, if the meal is below the target amount of calories and fat, the user may decide to select a food from the fats category to add to the meal.

Once the user has created a meal using the method of FIG. 1, the user may save the meal. The method may be repeated to create additional meals. The user may create any desired number of meals to be included in their diet plan.

When creating a meal, the user may take into consideration additional factors. For example, when the meal is within +/−5 g of fat or carbohydrate goals one can just accept the discrepancy and make note of it. If one is at +5 g of extra carbs or fat consistently and one gains weight instead of loses, one may consider adjusting intake down in the next week.

If bodyweight based protein needs do not meet L-Factor Points for a given protein, one must add supplemental protein or leucine to meals. This can be done in the form of added protein (chicken, fish, lean meats, whey/casein/soy/egg protein) or a supplement. If the user's goal is to get lean or health maintenance and the extra protein brings in extra fat calories, the user should consider reducing the calories from carbs by around the same amount. If the user's goal is to build muscle, the user should accept the extra protein and fat calories without any other changes.

Often just adding 1 gram of leucine (10 L-Points) to a meal from a supplement will suffice if one is meeting the 1 gram of protein per pound of bodyweight requirements through high quality complete proteins. If using a leucine pill, this will not count toward daily calories. Using bars or foods will need to adjust fats and carbs as below.

Additional snacking or eating of treats will need to be considered by adjusting the diet in future meals or added exercise. In general, sugar is the enemy to success. Limit fruits and sugars to essential timing; i.e. add as post-workout carbs or during intense training/competition sessions. Snacking should come in the form of tree nuts and fresh fibrous veggies; almonds, cashews, walnuts, pistachios, pecans, broccoli, cauliflower, celery, etc. It is preferred that snacking is avoided as much as possible as one should be able to stick to the 5MAD diet which means meals are every 3 hours.

If one breaks from the scheduled diet plan, get back on track with the next meal by not over eating and just be certain to achieve the L-Factor Point goal. If one over-eats carbs or fats in one meal try to cut back a little on subsequent meals that day, but maintain protein intake to achieve needed Leucine.

One must reach a minimum L-Factor Points with each of the 5 meals. It is best to have fat and carbohydrate evenly divided between meals but this is less critical than the protein. If one wants to have a meal with a little more fat (i.e. salmon instead of tilapia) then have less fat in a following meal (i.e. chicken breast or egg white).

### Using Condiments

Condiments should be used in a complimentary way. If the user's goal is health maintenance category, utilize them in moderation with attention to the calories if used in large amounts. If one want to use a salad dressing such as oil and vinegar it should be calculated as part of fat calories. Mustard is better than ketchup (ketchup often has sugar) and mayo is rarely healthy. Spices are a great way to add flavor without calories; cinnamon, nutmeg, garlic powder, pepper, turmeric, basil, cayenne, etc. Occasionally spices will add some health benefit. i.e cinnamon improves blood glucose levels, curcumin/turmeric reduces inflammation, cayenne peppers improve metabolic rate.

### Beverages

Sugar-free beverages such as water, coffee, Crystal light, artificially sweetened waters, etc. are allowed ad lib. Black coffee is encouraged for its antioxidant benefits and mind/body boosting caffeine. Stay hydrated with at least an 8-ounce glass of water with or after each meal.

### Essential Supplements

Take a multivitamin, 2 g of Omega-3 oils, Vitamin D 2000 iu (if not in the multivitamin), and a probiotic supplement daily.

### Nutrient Timing and Workouts

Time meals such that a protein+/−carbohydrate meal follows a workout session within 1 hour. If the user's goal is to build muscle, have half of the meal before the workout session and the other half after. If the user's goal is health maintenance, the meal can be had after the workout session or split. Those in the get lean category should keep the meal as a post-workout meal. Users whose goal is to get lean should skip carbs in the post-workout meal and place it evenly in other meals or use its absence as part of their caloric deficit.

By delaying the intake of carbs after a workout, one continues the fat burning potential of the workout for a few hours.

Green Leafy Veggies are a “Free Food”. A user may have as much as wanted of spinach, broccoli, asparagus, kale, lettuce, and sprouts. The user interface may contain a list of free foods that the user may add to a meal. Addition of the free foods will not count toward any of the target amount. Don't worry about counting all the calories from these veggies. Recommended to eat one of these veggies with each meal. Eat this list in moderation. Consider cutting back on the volume if bloated or fail to achieve weight loss goals. Broccoli, Broccolini, Spinach, Kale, Brussel Sprouts, Asparagus, Lettuce, Cabbage, Arugula, celery, Cauliflower, Radish, Watercress, Bok Choy, Sea Weed/Kelp.

The method of FIG. 1 can simply the process of creating a diet by assisting with the tracking of the amount of Leucine, calories and macronutrients in each meal and their relation to their corresponding target amounts. The following are examples of diet and exercise plans. Similar plans may be created for other users.

### Example Diet and Exercise Plan for Getting Lean

### Typical Day:

### Wake at 6 am

Fasted Morning Cardio (3 to 5 days per week): Goal to reach a heart rate of ˜140 beats per minute for 15 min of a 30 minute cardio session. No food prior to exercise. May have water or black coffee. May also take some HMB and/or a fat burning supplement prior to cardio.

### ˜7 am Breakfast

Goal is 24 g of protein per meal, 22 g of carbs per meal, 15 g of fats per meal and adjusting this based on leucine needs of 24 LFPs. If our dieter chooses eggs for breakfast, 1 ounce of egg whites have 2.9 LFPs, 3.1 grams of protein and 0 grams of fat or carbohydrate. An egg yolk has 3.9 LFPs per ounce, 4.5 grams of protein, 7.5 grams of fat, and 1 gram of carbohydrate. Since the goal is only 15 grams of fat per meal, the user can start with 2 ounces of egg yolks=7.8 LFPs, 9 grams of protein, 15 grams of fat and 2 grams of carbohydrate. The user needs to fill the 16.2 remaining LFPs to the target so 16.2/2.9 LFPs in an egg white=5.6 ounces of egg white. This gives us 17.4 grams of protein from egg white plus the 9 grams from the yolks for a total of 26.4 grams of protein (meeting our 24 g protein requirement). Since 2.4 grams of protein over the needed protein, remove those grams from carbohydrate leaving 17.6 grams of carbs for the meal. This can be obtained from a slice of Ezekial bread or an ounce of oatmeal (dry weight).

Feel free to add some greens to the eggs as an omelet as a free food, or add cheese but take away an egg yolk in equal amounts of fat or carbohydrate.

### ˜10 am Mid-Morning Meal

This meal can be the same as breakfast, a similar lunch meal, or a protein bar or shake that meets macronutrient needs. A 35 year old get lean female would strive for 20 grams of whey protein for a total of 20 LFPs. Furthermore, she could add an ounce of peanuts or almonds for an additional 4 LFPs, 14 grams of fat, ˜6 grams of protein and about 5 grams of carbs. This results in 2 extra grams of protein removed from carbs for 20 grams of carbs minus the 5 grams from the nuts=15 grams of carbs remaining. This would be a time where out of simplification, one could shift the non-consumed carbohydrates of 15 grams to either more in the lunch or post-workout meal, have a small piece of fruit (such as ½ of an unripe banana in a shake), or just resolve it as a slight caloric deficit.

### ˜1 pm Lunch

This meal can be the same as dinner or any of the other meals. Recommend a meat or fish with a veggie and complex carb, for example, salmon. To reach 24 LFPs farmed salmon has 5.1 LFPs per ounce with 7.2 grams of protein and 2.1 grams of fat. Approximately 4 ounces of salmon would give nearly 24 LPFs, 25.2 grams of protein, and 14 grams of fat. If subtract the additional protein from the carbohydrate, this leaves 20.8 grams of carbs, and 1 gram of fat. 2.5 ounces of yams can give another 19.5 grams of carbs and 1 gram of protein for a substantially complete meal that meets without exceeding macros. Greens may be included as they are a free food. Broccoli, Kale, Spinach, Asparagus, etc; just don't throw oils on them without removing the fats from the meat/fish or calories from the carb.

### ˜4-5 pm Post-Workout Nutrition

This could be time to get to the gym for a weight lifting workout, circuit training, or HIIT exercise routine. Consider trying the Century Club Challenge (CCC) exercises in small upper or lower body circuits with or without core exercises. The CCC can be used as a starting point for building a lean body with the ability to move bodyweight. Also can take a traditional bodybuilding approach to exercise routines or mix in cross training style workouts with HIIT, weights, machines, and plyometrics.

Consider a fast absorbed protein for this meal like whey protein isolates or hydrolyates. 20 grams of whey protein with 1 ounce of peanuts and 3 ounces of an unripe banana will fulfill the 24 LFPs, 26 grams of protein, 14 grams of fat and ˜20 grams of carbs. Having a little more post-workout carbs is okay as one tends to utilize those carbs to restore muscle glycogen better than creating more fat. Avoid eating any carbs before training to keep the fat burning machinery running. If planning to lift heavier or planning to train for performance, then consider having half of a meal 30 minutes prior and the other half immediately after training.

### ˜7 to 8 pm Dinner

Repeat a very similar meal to lunch or consider a mix of proteins, fats, and carbs. Consider reducing carbs in this meal and adding the calories to fat or protein if want to turn on a little less sugar storage. For top Sirloin Steak (fat trimmed lean cut), can eat ˜3 ounces obtaining 25.5 LFPs, 25 grams of protein, and 4.5 grams of fat. This leaves 21 grams of carbs and 10.5 grams of fat. One can have 3 ounces of brown rice for 19.5 grams of carbs and maybe add a little (1 ounce) of Swiss cheese to green leafy salad or meat for 8.4 LFPs, 7 grams of protein, 1.4 grams of fat, and 1.2 grams of carbs. Here, have exceeded LFPs and protein but not fat or carbohydrate. To be closer to fat intake goal, consider a fattier meat (ie ground beef or turkey) or fish.

Again, for the “get lean” category, accept a little more calorie deficit at first. If losing too much weight, or too hungry, be stricter at meeting macronutrient goals.

### Example Diet and Exercise Plan for Building Muscle

Consider a 35 year old, 5′9″ male who weighs 170 lbs and wants to put on 15 pounds of muscle. Calculate calorie and macronutrient needs based on goal body weight of 185 lbs. This man likes to train 5 days per week in the gym with high intensity for an activity factor of 1.55. Thus, total daily energy expenditure is:

BMR=66+(6.23×weight in pounds)+(12.7×height in Inches)−(6.8×age in years)

BMR=66+(6.23×185)+(12.7×69)−(6.8×35)=66+(1152.55)+(876.3)−(238)=1856.85

1856.85 Calories×Activity factor of 1.55=Total of 2878 Calories per day.

Since this man wants to gain muscle, add another 250 Calories to this total for a summary of =3128 per day

Thus, he needs 625 Calories per meal, 37 LFPs, and a minimum of 37 grams of protein per meal.

Calories in 37 grams of protein is (37×4 Calories/gram)=148 calories

625−148=477 remaining calories. Muscle builders divide those remaining calories into 60% carbohydrates and 40% fats. Thus:

286 Calories as carbs/4 Calories per gram=72 grams of carbohydrate per meal 191 Calories as Fat/9 Calories per gram=21 grams of fat per meal

### Typical Day:

### ˜7 am Breakfast

Goal is 37 g of protein per meal, 72 g of carbs per meal, 21 g of fats per meal and adjusting this based on leucine needs of 37 Leucine Factor Points (LFPs). If builder chooses eggs for breakfast 1 ounce of egg whites have 2.9 LFPs, 3.1 grams of protein and 0 grams of fat or carbohydrate. An egg yolk has 3.9 LFPs per ounce, 4.5 grams of protein, 7.5 grams of fat, and 1 gram of carbohydrate. Since the goal is only 21 grams of fat per meal, one can start with 3 ounces of egg yolks=11.7 LF-Points, 13.5 grams of protein, 22.5 grams of fat and 3 grams of carbohydrate. This mildly overshoots the fat needs but within acceptable limits for someone who wants to gain muscle. (avoid overshooting by more than 5 grams of fat per meal in a builder).

Now, need to fill the LFPs remaining of 25.3 so 25.3/2.9 LFPs in an egg white=8.7 ounces of egg white. This gives 27 grams of protein from egg white plus the 13.5 grams from the yolks for a total of 40.5 grams of protein (meeting our 37 g protein requirement). Since a muscle builder, can except extra protein calories without consequence. Now can add in a carbohydrate to meet the 69 grams of carbohydrate remaining. This can be obtained from a combination of a piece of fruit and oatmeal or a couple pieces of Ezekial bread.

Add some greens to the eggs as an omelet as a free food, or add cheese but take away an egg yolk in equal amounts of fat or carbohydrate.

### ˜10 am Mid-Morning Meal

This meal can be the same as breakfast, a similar lunch meal, or a protein bar or shake that meets macronutrient needs. A 35 year old muscle builder would strive for 37 grams of whey protein for a total of 37 LFPs. Furthermore, he could add 1.5 ounce of peanuts or almonds for an additional 6 LFPs, 21 grams of fat, ˜9 grams of protein and about 7 grams of carbs. Another option is to have a peanut butter or almond butter sandwich with Ezekial bread for a total of 30 grams of carbs. This results in 9 extra grams of protein that can be accepted without consequence. A piece of fruit such as an unripe banana or a cup of blueberries in a shake can provide the further needed carbohydrates. 2% Milk can also provide some fats and carbohydrate, so consider using milk in the shake to replace some fruit carbs and nut butter fats.

### ˜1 pm Lunch

This meal can be the same as dinner or any of the other meals. Recommend a meat or fish with a veggie and complex carb, for example, 85% ground beef. To reach 37 LFPs 85% ground beef has 6.1 LFPs per ounce with 7.9 grams of protein and 3.7 grams of fat. Approximately 6 ounces of 85% ground beef would give us 37 LPFs, 47.4 grams of protein, and 22.2 grams of fat. Now, need to add some carbohydrate. Yams have 7.8 grams per ounce and brown rice has 6.5 grams per ounce. Again, a piece of fruit or even dairy like Greek yogurt or mozzarella cheese can replace some of the protein and supply some fat and carbohydrate needs.

Add some greens in as they are a free food. Broccoli, Kale, Spinach, Asparagus, etc; just don't throw oils on them without removing the fats from the meat/fish or calories from the carb.

### ˜4-5 pm Post-Workout Nutrition

This could be time that to get to the gym for a weight lifting workout. Consider a fast absorbed protein for this meal like whey protein isolates or hydrolyates. 40 grams of whey protein and a fast acting carb such as fruit or a waxy-maise starch added to a shake will aid in glycogen replenishment and get insulin flowing to push nutrients into muscle. If planning to lift heavier or planning to train for performance, then consider having half of the meal 30 minutes prior and the other half immediately after training. Leave most of the fats for after training. Consider trying MCT oil or Coconut Oil as a fat source in shakes as well.

### ˜7 to 8 pm Diner

Repeat a very similar meal to lunch or consider a mix of proteins, fats, and carbs. If picking a meat like Top Sirloin Steak, can have 4.4 ounces obtaining 37 LFPs, 37 grams of protein, and ˜7 grams of fat. This leaves 72 grams of carbs and 14 grams of fat. Can have a bowl of whole wheat pasta with olive oil to meet carbohydrate and fat needs. Adding some olive or sunflower oil to a salad or choosing a fattier meat can help meet fat needs.

### Example Diet and Exercise Plan for Health Maintenance

The health maintenance diet is designed for those who feel they have attained their goal of a healthy bodyweight and adequate lean muscle. These individuals may come at all activity levels. They want to maintain performance without any particular desire to build more muscle or lose weight.

These individuals have to adjust their diet just as much as the muscle builder or get lean dieter. As much math is involved there's inherent error in the normative values on which the math is based. If a diet is not getting one to desired goals (i.e. maintaining a healthy physique) there is a need to adjust. May adjust calorie needs up or down before changing goal routine.

The health maintenance person needs just as much Leucine as others. If muscles are not used and stimulated with leucine, one will lose it just like any other aging person. Our sensitivity to leucine and its muscle boosting effects decreases with age. The older one gets, the more leucine one needs to maintain muscle.

A 5′6″ 45 year old female that has reached a healthy weight of 140 pounds and wants to maintain this weight while living a relatively active lifestyle at an activity factor of 1.55.

BMR=655+(4.35×weight in pounds)+(4.7×height in Inches)−(4.7×age in years)

BMR=655+(4.35×140)+(4.7×66)−(4.7×45)=655+(609)+(310.2)−(211.45)=1363

1363 calories×Activity factor of 1.55=Total of 2112 calories per day

Thus she needs 422 calories per meal, 28 LFPs, and a minimum of 28 grams of protein per meal.

Calories in 28 grams of protein is (28×4 calories/gram)=112 calories

422−112=310 remaining calories. Health Maintainers divide those remaining calories into 50% carbohydrates and 50% fats. Thus:

155 calories as carbs/4 calories per gram=39 grams of carbohydrate per meal

155 calories as Fat/9 calories per gram=17 grams of fat per meal

### Example Meals for Health Maintenance

### Breakfast

2% Cottage Cheese has 3 LFPs, 3 grams of protein, 0.6 grams of fat, and 1.3 grams of carbs per ounce. 8 ounces of 2% Cottage Cheese gives 24 LFPs, 24 grams of protein, 5 grams of fat, and 10 grams of carbs. 2 slices of Ezekial bread supplies 28 grams of carbs and 10 grams of additional protein. The excess calories from protein of 6 grams can be removed from carbs or fat equally. Since the bread meets the needs of carbs, the 24 calories removed equal about 3 grams of fat (6 grams of protein=24 Calories; 24 Calories/9 Calories per gram=2.66 rounded to 3 grams). Thus, to get slightly more grams of fat one can either add 1 table spoon of olive oil based butter or natural peanut butter. One of the pieces of bread can be replaced by frozen blueberries or pineapple in the cottage cheese.

### Lunch

A grilled chicken breast has 7.2 LFPs, 8.7 grams of protein, and 1 gram of fat per ounce. 1 ounce of low fat Swiss cheese has 8.4 LFPs, 7.2 grams of protein, and 1.4 grams of fat, and 1.2 grams of carbs. If one makes a sandwich with 1 ounce of low fat swiss this leaves ˜20 LFPs. 3 oz Chicken breast with 1 ounce of Swiss cheese provides 30 LFPs, 33.3 grams of protein, and 4.4 grams of fat. A typical hamburger bun may have 20 grams of carbohydrate and 2 grams of fat. Some avocado can be added to reach fat intake needs, and a piece of fruit will meet remaining carbohydrate needs.

### Dinner

Pork tenderloin has 6.8 LFPs, 8.3 grams of protein, and 2.4 grams of fat per ounce. Thus 4 ounces of pork tenderloin gives nearly 28 LFPs and ˜10 grams of fat. This leaves 7 grams of fat and need for a carbohydrate source. 5 ounces of yams would provide the needed carbohydrate of 39 grams and some oil on a salad with spinach and broccoli would meet the fat needs.

The method of FIG. 1 may be used to assist with implementing any of the above plans. For example, the method of FIG. 1 may be implemented in an electronic device such as, without limitation, a smartphone. The user may interact with the electronic device to select foods for meals to create the plan. The electronic device may perform the calculations to determine the target amounts of Leucine, calories and each macronutrient. The electronic device may also calculate the amounts of Leucine, calories and each macronutrient provided by the foods the user has selected for the meal and display a comparison of the amount and target amount for the user. Thus, it is simple for the user to select foods to add or remove from a meal to create a meal that has the target amount of Leucine, calories and each macronutrient.

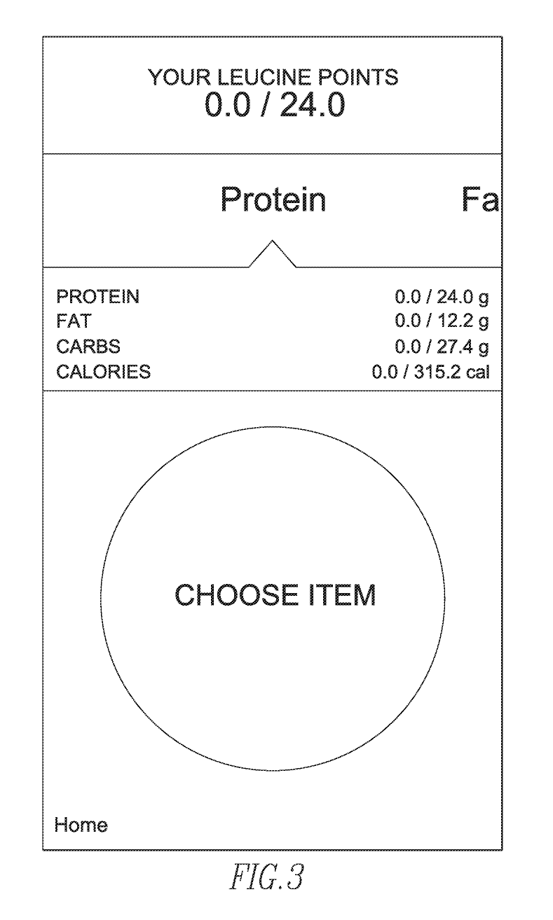

FIG. 2 is a schematic diagram of an electronic device 100 in accordance with an example embodiment of the disclosed concept. The electronic device 100 may be used to implement the method of FIG. 1. In some example embodiments, the electronic device includes a processing unit 110, a memory 120 including a routine 130 stored therein, a display 140, and an input interface 150.

The processing unit 110 unit may include a processor. The processor may be, for example and without limitation, a microprocessor, a microcontroller, or some other suitable processing device or circuitry.

The memory 120 may be any of one or more of a variety of types of internal and/or external non-transitory storage media such as, without limitation, RAM, ROM, EPROM(s), EEPROM(s), FLASH, and the like that provide a storage register, i.e., a machine readable medium, for data storage such as in the fashion of an internal storage area of a computer, and can be volatile memory or nonvolatile memory.

In some embodiments of the disclosed concept, one or more routines 130 that may be executed by the processor may be stored in the memory 120. For example, executing the routine 130 may cause the process to implement the method of FIG. 1. In some example embodiments of the disclosed concept, the memory 120 and routine 130 may be included in the processing unit 110.

The display 140 may be a display screen and/or touch screen, which may be any size and/or shape and may be located at any portion of the electronic device 100. Various types of displays 140 may include, but are not limited to, liquid crystal displays (“LCD”), monochrome displays, color graphics adapter (“CGA”) displays, enhanced graphics adapter (“EGA”) displays, variable graphics array (“VGA”) display, or any other type of display, or any combination thereof. Still further, a touch screen may, in some embodiments, correspond to a display screen including capacitive sensing panels capable of recognizing touch inputs thereon.

The input interface 150 facilitates the user providing user information to the electronic device 100. In some example embodiments of the disclosed concept, the input interface 150 is a touch screen. It is contemplated that a single touch screen may serve as both the input interface 150 and the display 140. However, other suitable input interfaces 150 may be employed as well. For example, a microphone and corresponding voice recognition software may be employed as the input interface 150. In yet other example embodiments, an input device such as a mouse or keyboard may be employed as the input interface 150.

The electronic device 100 may be any suitable type of electronic device. For example, as previously described, the electronic device may be a smartphone. However, it is contemplated that the electronic device 100 may be a laptop computer, a desktop computer, a tablet, various types of mobile devices, or any other suitable type of device without departing from the scope of the disclosed concept.

FIGS. 3-5 are examples of screens in a user interface in accordance with an example embodiment of the disclosed concept. The screens shown in FIGS. 3-5 are examples of screens that may be used in the method of FIG. 1 and/or displayed on the electronic device 100 of FIG. 2 when it implements the method of FIG. 1.

FIG. 3 illustrates a screen of a user interface that allows a user to add food to a meal. The user may select a category of food by scrolling to the selecting category. The category “Protein” in selected in FIG. 3. The user may then access the list of foods in the selected category by interacting with the “CHOOSE ITEM” button.

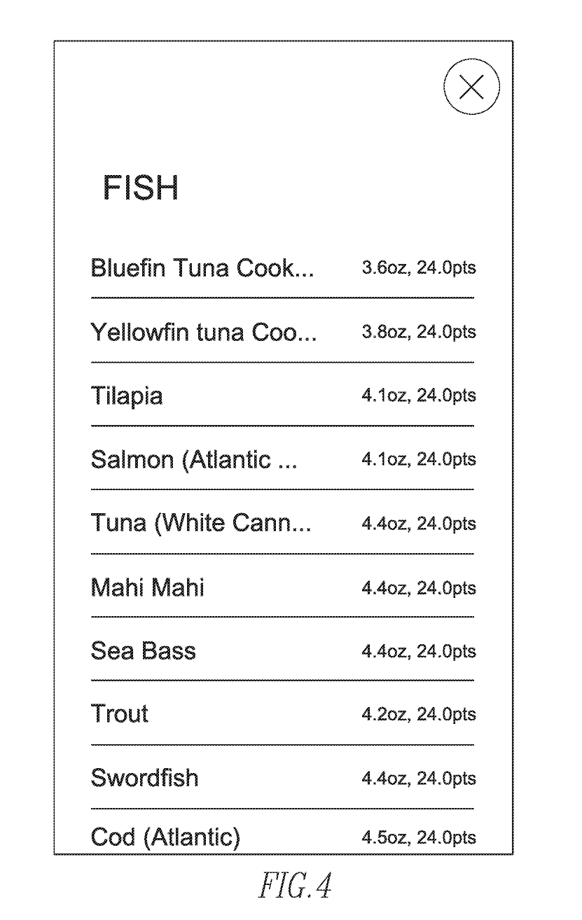

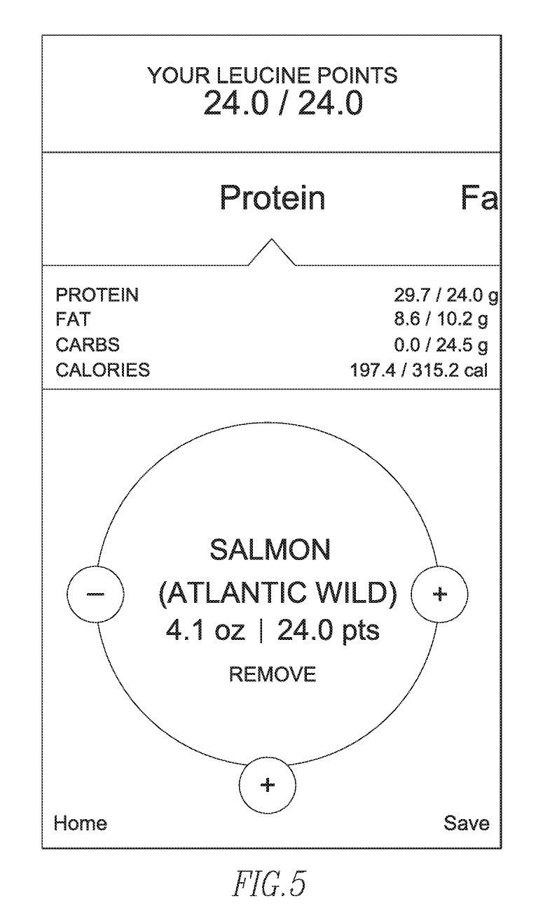

FIG. 4 illustrates an example of a list of foods included in the protein category. In some example embodiments, the list of foods shown in FIG. 4 is displayed in response to the user interacting with the “CHOOSE ITEM” button of FIG. 3 when the category “Protein” is selected. As shown in FIG. 4, various different foods are shown in the list. The user may scroll through the list to display additional foods. The amount of each food and the LFPs associated with the amount of that food are also shown on the screen. Interacting with one of the foods in the list will add it to the meal. For example, interacting with “Salmon (Atlantic Wild)” will add 4.1 oz of Salmon (Atlantic Wild) to the meal. In response to interacting with one of the foods, the screen shown in FIG. 5 may be displayed.

FIG. 5 illustrates a screen that may be displayed in response to selecting a food to add to the meal. As shown in FIG. 5, Salmon, Atlantic Wild is displayed. Interacting with the “REMOVE” button will remove it from the meal. Interacting with the “−” and “+” buttons to the left and right of the name of the food item will reduce or increase the amount of the food, respectively. Interacting with the “+” below the name of the food will take the user to the food list to select another food to add to the meal.

As shown in FIG. 4, a list of the amount of Leucine, protein, fat, carbs and calories included in the meal is displayed. Additionally, target amounts of Leucine (displayed as LFPs), protein, fat, carbs and calories are displayed to the right of their current amounts. Each time a food is added to the meals the amounts are updated. For example, in FIG. 3, the amounts of Leucine, protein, fat, carbs and calories were zero, but in FIG. 4, after adding the Salmon (Atlantic Wild), the amounts have been updated to reflect the addition of the Salmon (Atlantic Wild).

The disclosed concept can also be embodied as computer readable codes on a tangible, non-transitory computer readable recording medium. The computer readable recording medium is any data storage device that can store data which can be thereafter read by a computer system. Non-limiting examples of the computer readable recording medium include read-only memory (ROM), non-volatile random-access memory (RAM), CD-ROMs, magnetic tapes, floppy disks, disk storage devices, and optical data storage devices.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A method of creating a meal plan, the method comprising:
receiving user information;
determining target amounts of leucine, calories and one or more macronutrients per meal based on the received user information;
providing a user interface to allow the user to add food items to a created meal or remove food items from the created meal;
determining amounts of leucine, calories and one or more macronutrients provided by food items included in the created meal;
displaying a comparison of the amounts of leucine, calories and one or more macronutrients provided by food items in the created meal and the target amounts of leucine, calories and one or more macronutrients per meal on the user interface; and
updating the displayed comparison each time the user adds a food item to the created meal or removes a food item from the created meal.

2. The method of claim 1, wherein the user information includes at least one of gender, age, height, desired weight, activity level, and user goal.

3. The method of claim 2, wherein determining target amounts of leucine, calories and one or more macronutrients per meal based on the received user information comprises:
determining the target amount of leucine per meal as 0.2 leucine factor points times the desired weight.

4. The method of claim 2, wherein determining target amounts of leucine, calories and one or more macronutrients per meal based on the received user information comprises:
determining a total daily energy expenditure based on at least the gender, age, height, and desired weight;
adjusting the total daily energy expenditure based on the activity factor or the user goal; and
dividing the adjusted total daily energy expenditure by a number of meals per day to determine the target amount of calories per meal.

5. The method of claim 4, wherein the total daily energy expenditure is determined using one of the following equations:
66+(6.23×desired weight in pounds)+(12.7×height in inches)−(6.8×age in years); (a)
655+(4.35×desired weight in pounds)+(4.7×height in inches)−(4.7×age in years); (b)
wherein equation (a) is used if the gender is male and equation (b) is used if the gender is female.

6. The method of claim 4, wherein the one or more macronutrients include protein, fats, and carbohydrates, and wherein determining target amounts of leucine, calories and one or more macronutrients per meal based on the received user information comprises:
determining a daily amount of protein as 1 g per pound of the desired weight;
subtracting calories provided by the daily amount of protein from the adjusted daily energy expenditure to obtain a remaining amount of calories;
allocating the remaining amount of calories between carbohydrates and fats based on the user goal;
determining daily amounts of carbohydrates and fats based on the amount of calories allocated to carbohydrates and fats; and
dividing the daily amount of protein, carbohydrates, and fats by the number of meals per day to determining target amount of protein, carbohydrates, and fats per meal.

7. The method of claim 1, further comprising:
providing a protein category including a list of selectable foods in the user interface;
calculating amounts of food in the protein category needed to meet the target amount of leucine per meal; and
displaying the amounts of food in the protein category needed to meet the target amount of leucine per meal.

8. The method of claim 1, further comprising:
determining if the amounts of leucine, calories, or one or more macronutrients provided by food items in the created meal are not within predetermined thresholds of their corresponding target amounts; and
displaying an indication which amounts of leucine, calories, or one or more macronutrients provided by food items in the created meal are not within predetermined thresholds of their corresponding target amounts.

9. The method of claim 8, wherein displaying the indication comprises:
changing a text color of displayed amounts of leucine, calories, or one or more macronutrients that are not within predetermined thresholds of their corresponding target amounts.

10. The method of claim 1, further comprising:
determining if the amount of leucine provided by food items in the created meal is less than the target amount of leucine per meal; and
if the amount of leucine provided by food items in the created meal is less than the target amount of leucine per meal, providing a prompt for the user to boost the amount of leucine in the meal.

11. A non-transitory computer readable medium storing one or more programs, including instructions, which when executed by a computer, causes the computer to perform the method of claim 1.

12. An electronic device comprising:
an input device;
a display;
a memory having stored therein a routine; and
a processing unit structured to execute the routine, wherein executing the routine causes the processing unit to:
receive user information;
determine target amounts of leucine, calories and one or more macronutrients per meal based on the received user information;
provide a user interface on the display to allow the user to add food items to a created meal or remove food items from the created meal;
determine amounts of leucine, calories and one or more macronutrients provided by food items included in the created meal;
control the display to display a comparison of the amounts of leucine, calories and one or more macronutrients provided by food items in the created meal and the target amounts of leucine, calories and one or more macronutrients per meal on the user interface; and
updating the displayed comparison each time the user adds a food item to the created meal or removes a food item from the created meal.

13. The electronic device of claim 12, wherein the user information includes at least one of gender, age, height, desired weight, activity level, and user goal.

14. The electronic device of claim 13, wherein the routine stored in the memory, when executed by the processing unit, further causes the processing unit to:
determine the target amount of leucine per meal as 0.2 leucine factor points times the desired weight.

15. The electronic device of claim 13, wherein the routine stored in the memory, when executed by the processing unit, further causes the processing unit to:
determine a total daily energy expenditure based on at least the gender, age, height, and desired weight;
adjust the total daily energy expenditure based on the activity factor or the user goal; and
divide the adjusted total daily energy expenditure by a number of meals per day to determine the target amount of calories per meal.

16. The electronic device of claim 15, wherein the total daily energy expenditure is determined using one of the following equations:
66+(6.23×desired weight in pounds)+(12.7×height in inches)−(6.8×age in years); (a)
655+(4.35×desired weight in pounds)+(4.7×height in inches)−(4.7×age in years); (b)
wherein equation (a) is used if the gender is male and equation (b) is used if the gender is female.

17. The electronic device of claim 15, wherein the one or more macronutrients include protein, fats, and carbohydrates, and wherein the routine stored in the memory, when executed by the processing unit, further causes the processing unit to:
determine a daily amount of protein as 1 g per pound of the desired weight;
subtract calories provided by the daily amount of protein from the adjusted daily energy expenditure to obtain a remaining amount of calories;
allocate the remaining amount of calories between carbohydrates and fats based on the user goal;
determine daily amounts of carbohydrates and fats based on the amount of calories allocated to carbohydrates and fats; and
divide the daily amount of protein, carbohydrates, and fats by the number of meals per day to determining target amount of protein, carbohydrates, and fats per meal.

18. The electronic device of claim 12, further comprising:
provide a protein category including a list of selectable foods in the user interface;
calculate amounts of food in the protein category needed to meet the target amount of leucine per meal; and
control the display to display the amounts of food in the protein category needed to meet the target amount of leucine per meal.

19. The electronic device of claim 12, wherein the routine stored in the memory, when executed by the processing unit, further causes the processing unit to:
determine if the amounts of leucine, calories, or one or more macronutrients provided by food items in the created meal are not within predetermined thresholds of their corresponding target amounts; and
control the display to display an indication which amounts of leucine, calories, or one or more macronutrients provided by food items in the created meal are not within predetermined thresholds of their corresponding target amounts.

20. The electronic device of claim 19, wherein the routine stored in the memory, when executed by the processing unit, further causes the processing unit to:
change a text color of displayed amounts of leucine, calories, or one or more macronutrients that are not within predetermined thresholds of their corresponding target amounts.

21. The electronic device of claim 12, wherein the routine stored in the memory, when executed by the processing unit, further causes the processing unit to:
determine if the amount of leucine provided by food items in the created meal is less than the target amount of leucine per meal; and
if the amount of leucine provided by food items in the created meal is less than the target amount of leucine per meal, provide a prompt for the user to boost the amount of leucine in the meal.

22. The electronic device of claim 12, wherein the electronic device is a mobile phone.
